(19) United States
(12) Patent Application Publication
(10) Pub. No.: US 2026/0222851 A1
(43) Pub. Date: Jul. 30, 2026

(54) VIRTUAL BANDWIDTH PART-BASED INTERFERENCE MEASUREMENT

(71) Applicant: QUALCOMM Incorporated, San Diego, CA (US)

(72) Inventors: Liangping MA, San Diego, CA (US); Huilin XU, Temecula, CA (US)

(21) Appl. No.: 19/041,591

(22) Filed: Jan. 30, 2025

(51) Int. Cl. H04W 24/08; H04L 5/00; H04W 24/10; H04W 72/0453; H04W 72/23

(52) U.S. Cl. CPC H04W 24/08; H04L 5/0042; H04W 24/10; H04W 72/0453; H04W 72/23

(57) ABSTRACT

Certain aspects of the present disclosure provide techniques for virtual bandwidth part-based interference measurement. An example method includes obtaining an indication of a first downlink bandwidth part among a set of downlink bandwidth parts; obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and monitoring for the interference in the second downlink bandwidth part during a measurement occasion associated with the measurement resource.

### INTRODUCTION

### Field of the Disclosure

Aspects of the present disclosure relate to wireless communications, and more particularly, to techniques for cross-link interference measurement.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining an indication of a first downlink bandwidth part among a set of downlink bandwidth parts; obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and monitoring for the interference in the second downlink bandwidth part during a measurement occasion associated with the measurement resource.

Certain aspects provide a method for wireless communications by a network node. The method includes sending an indication of a first downlink bandwidth part among a set of downlink bandwidth parts; sending one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and obtaining a measurement report that includes an indication of the interference associated with the second downlink bandwidth part.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example non-terrestrial network.

FIG. 6 depicts an example of interference measurement in a wireless communications network.

FIG. 7 depicts an example frequency allocation of downlink bandwidth parts (BWPs) in a carrier.

FIG. 8 depicts an example scheme of BWP switching between a first downlink BWP and a second downlink BWP.

FIG. 9 depicts a process flow for virtual BWP-based interference measurement.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for virtual bandwidth part-based interference measurement. A bandwidth part (BWP) may be a contiguous frequency range (e.g., contiguous resource blocks) of a channel bandwidth of a carrier. The carrier may be a frequency range of one or more operating bands specified for wireless communications, such as an operating band of Frequency Range 1, Frequency Range 2, and/or any other future frequency ranges, as further described herein. A BWP may differ from a carrier in that a BWP occupies a subset of a carrier and in that the BWP can be dynamically switched between multiple configured BWPs (thus enabling adaptation of bandwidths, subcarrier spacings, and so on, without explicit reconfiguration of a carrier).

Certain wireless communication systems (e.g., Evolved Universal Terrestrial Radio Access (E-UTRA) systems, 5G New Radio (NR) systems, and/or future wireless communication systems) may facilitate communications coverage via a non-terrestrial network (NTN), such as a spaceborne (e.g., satellite) and/or airborne (e.g., airship, balloon, etc.) platform that provides wireless connectivity to user equipment (UE). In certain cases, frequency division duplex (FDD) spectrum sharing with reverse pairing (hereinafter “reverse spectrum sharing”) may be used to allocate downlink and uplink frequency spectrum among network nodes (e.g., base stations), such as a first network node of an NTN and a second network node of a terrestrial network (TN). As an example, under reverse spectrum sharing, the first network node may use a first frequency band and a second frequency band for downlink and uplink communications, respectively. The second network node may use the second frequency band and the first frequency band for downlink and uplink communications, respectively. Accordingly, the frequency bands used by the second network node for downlink and uplink communications may be a reverse pairing with respect to the frequency bands used by the first network node.

Technical problems for reverse spectrum sharing may include, for example, effective interference measurement at a UE communicating with a network node, for example, associated with a TN. In certain cases, a first UE communicating with a first network node in a reverse spectrum sharing environment may encounter cross-link interference (which is sometimes abbreviated as CLI) from one or more second UEs (hereinafter “the second UE”). Cross-link interference may occur when a device (e.g., a UE or network node) is transmitting while another device is receiving in the same frequency band. For example, the second UE may transmit uplink signaling to a second network node in the same frequency band as the first UE uses to receive downlink signaling from the first network node. In certain cases, the second UE may be referred to as an aggressor UE, due to the second UE being a source of cross-link interference encountered at the first UE; and the first UE may be referred to as a victim UE, due to the first UE encountering cross-link interference from another wireless communications device, such as the second UE.

In certain wireless communication systems (e.g., 5G NR systems), the first UE may be configured to measure the cross-link interference associated with the second UE based on sounding reference signal (SRS) and/or received signal strength indicator (RSSI) measurements. As an example, the second UE may be configured to transmit a SRS, and the first UE may be configured to receive the SRS and measure the signal strength of the received SRS. The signal strength may be indicative of the cross-link interference encountered at the first UE, for example, from the second UE. The first UE may be configured with certain measurement resource(s) to measure the CLI, such as an SRS measurement resource and/or an RSSI measurement resource. In certain cases, certain wireless communication systems (e.g., 5G NR systems) may specify, for cross-link interference measurements, that an SRS measurement resource and RSSI measurement resource is arranged within the frequency bandwidth of an active downlink BWP of the first UE, and that the SRS measurement resource has the same subcarrier spacing as the active downlink BWP of the first UE.

However, due to certain frequency pre-compensations (for example, Doppler shifts of ±40 kHz associated with uplink transmissions with low-earth orbit satellite(s)), the second UE may transmit signaling that partially overlaps with the frequency bandwidth of the active downlink BWP of the first UE in the frequency domain. As an example, a portion of the SRS transmission of the second UE may be outside the frequency bandwidth of the active downlink BWP of the first UE. Thus, the frequency bandwidth of the active downlink BWP of the first UE may be too narrow in the frequency domain to cover the entire frequency bandwidth of the SRS transmission output by the second UE. This may occur even when the second UE is configured to transmit the SRS within an uplink BWP that fully overlaps in the frequency domain with the active downlink BWP of the first UE, due to the frequency pre-compensations applied at the second UE. In certain cases, the second UE may transmit signaling to the second network node using a different subcarrier spacing as the active downlink BWP of the first UE. As an example, NTN communications may use a subset of subcarrier spacings among the subcarrier spacings used for TN communications. The SRS transmission of the second UE may apply a different subcarrier spacing than the subcarrier spacing of the active downlink BWP of the first UE. Thus, the first UE may not be able to measure certain cross-link interference from the second UE(s) based on certain specifications associated with SRS and RSSI measurement resources described above.

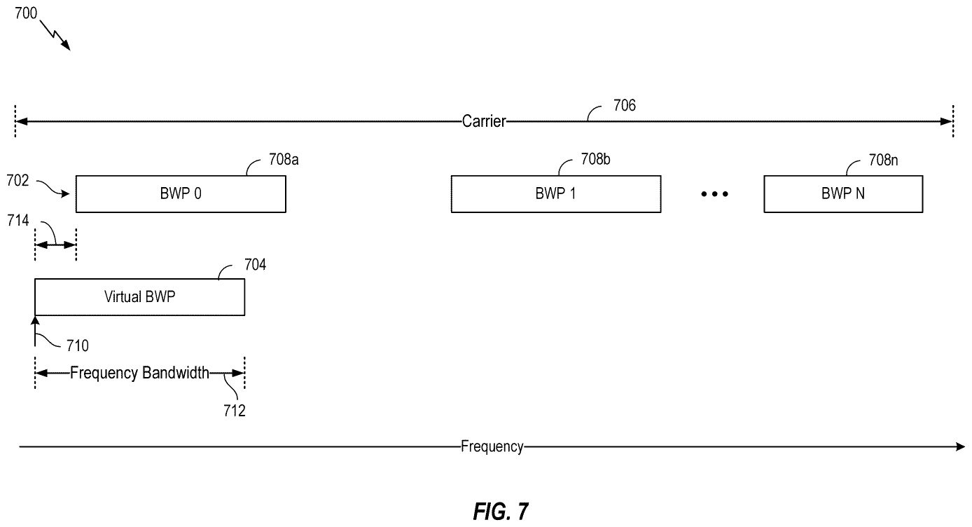

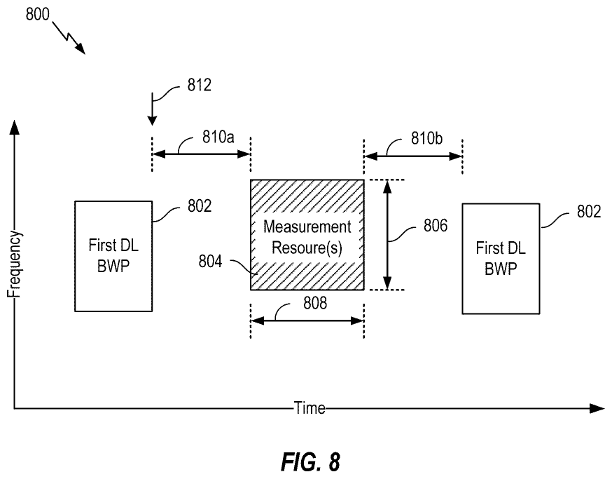

Certain aspects described herein may overcome the aforementioned technical problem(s), for example, by providing virtual BWP-based interference measurement that may comply with certain specification(s) associated with SRS measurement resources and/or RSSI measurement resources (as described above). A virtual BWP may refer to a BWP that is used only for measurement of channel conditions (such as interference) and not for downlink communications (such as control or data signaling). In certain cases, a virtual BWP may have a reduced configuration relative to BWP(s) having a cyclic prefix and/or configurations for downlink communications. The virtual BWP may be referred to as a measurement BWP or the like. A UE may be configured with a measurement resource based at least in part on a virtual BWP. The virtual BWP may be configured to match certain parameter(s) associated with certain interference, such as cross-link interference from an aggressor UE. In certain cases, the virtual BWP may have a frequency bandwidth wide enough to encompass the frequency bandwidth of the uplink transmissions of an aggressor UE that may apply certain frequency pre-compensations, for example, associated with an NTN. As an example, the virtual BWP may at least partially overlap in the frequency domain with a downlink BWP of the UE, as further described herein with respect to FIG. 7. In certain cases, the virtual BWP may have a different subcarrier spacing than a downlink BWP of the UE. As an example, the subcarrier spacing of the virtual BWP may match the subcarrier spacing of the aggressor UE. The UE may not count the virtual BWP towards the maximum number of downlink BWPs that may be configured per carrier. In certain cases, the UE may perform BWP switching to perform interference measurement. As an example, the UE may switch from an active downlink BWP to the virtual BWP before a measurement occasion associated with an interference measurement, as further described herein with respect to FIG. 8. Then, after the measurement occasion, the UE may switch from the virtual BWP to the active downlink BWP.

Certain techniques for interference measurement described herein may provide various beneficial technical effects and/or advantages. The techniques for interference measurement may enable improved wireless communications performance, such as reduced latencies, increased throughput, and/or the like. The reduced latencies and/or increased throughput may be attributable to the UE being able to detect, decode, and/or measure the cross-link interference associated with another UE, which may be communicating with an NTN. As an example, the virtual BWP may allow the UE to measure the full frequency bandwidth of certain transmissions (such as transmissions that apply frequency pre-compensations due to NTN communications). Thus, with the full frequency bandwidth, the UE may be able to detect and measure certain signaling communicated by an aggressor UE. The UE may be able to compare the received signals to the expected sequence of a reference signal (such as a sounding reference signal) across the frequency bandwidth used by the aggressor UE. In certain cases, the virtual BWP may allow the UE to use a subcarrier spacing that matches the subcarrier spacing of the aggressor UE. Thus, with the same subcarrier spacing, the UE may be able to detect and measure the signaling in the OFDM subcarriers used by an aggressor UE. In certain cases, when the virtual BWP is active, the UE may use reduced computational resources (e.g., processing and/or memory usage), for example, due to the virtual BWP only being used for interference measurement and not downlink communications.

Measurement of the cross-link interference at the UE may allow the UE and/or a network node to mitigate the effects of the cross-link interference, which may in turn enable reduced latencies and/or increased throughput. As an example, the UE may report the cross-link interference to a network node, which may adjust transmission parameters (e.g., a channel precoder) to mitigate the effects of the cross-link interference. In certain cases, the UE may adjust reception parameters (e.g., channel equalization) to mitigate the effects of the cross-link interference.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

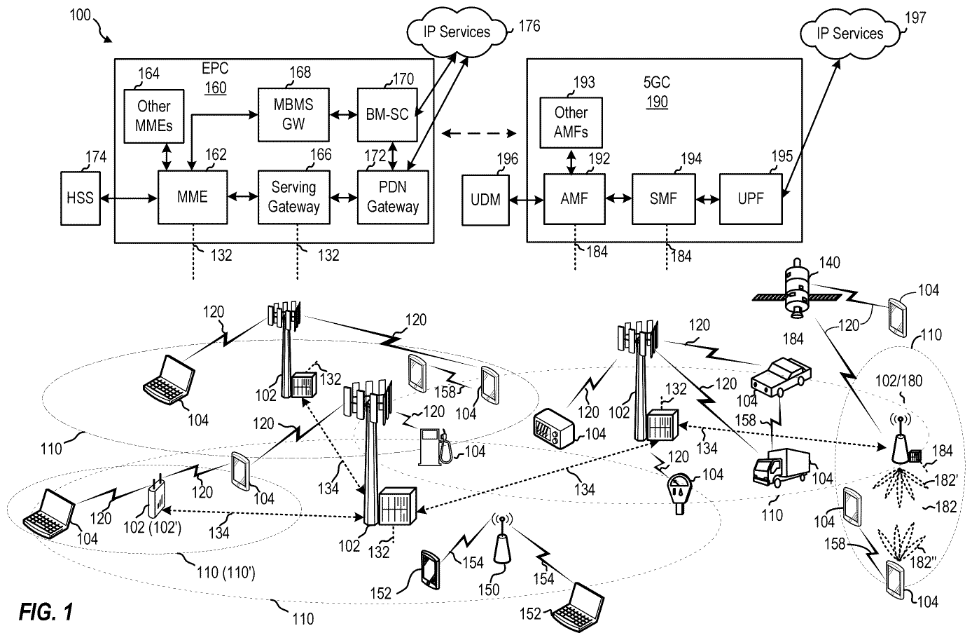

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In certain aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

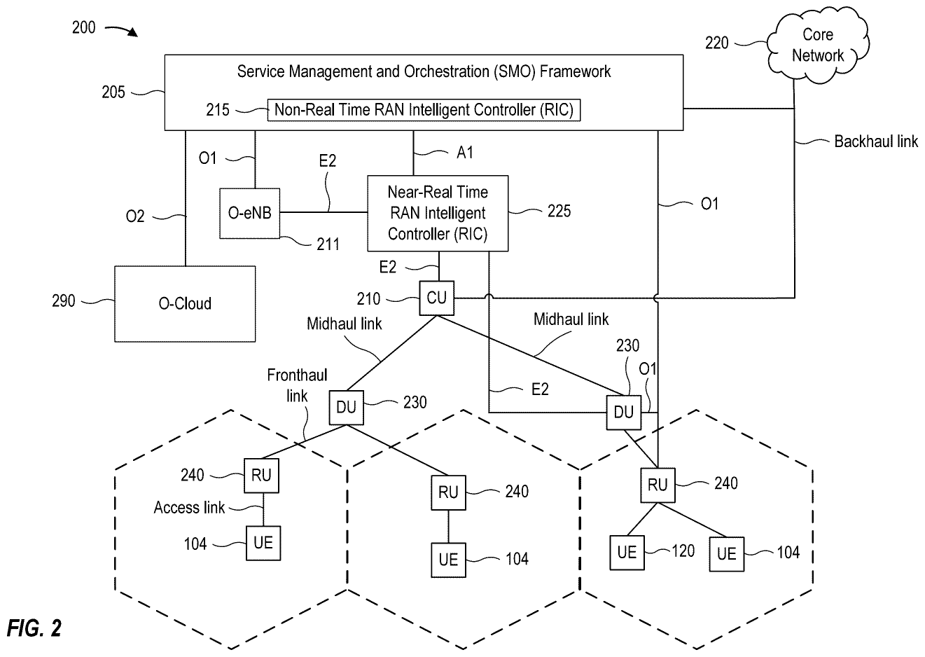

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In certain aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In certain aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub- 6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In certain aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In certain aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In certain aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

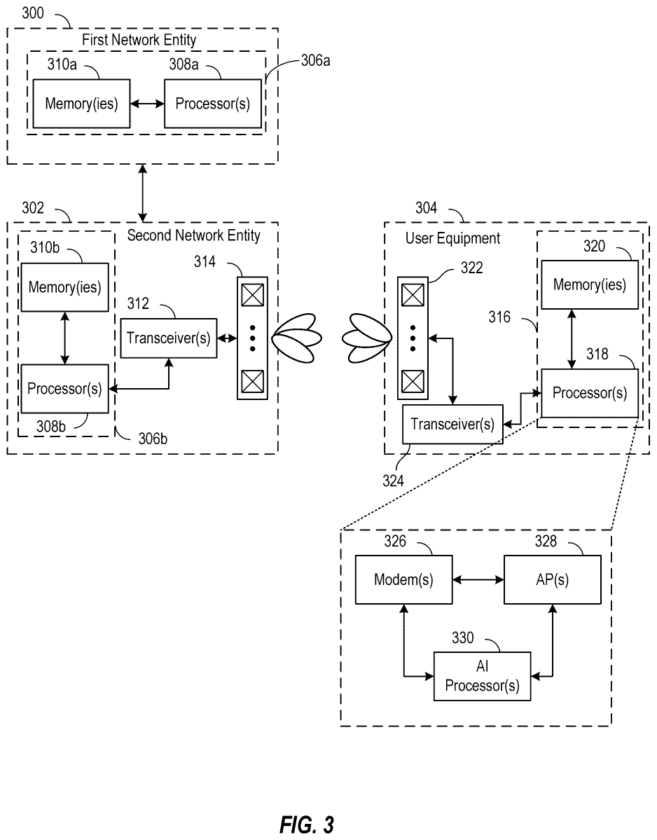

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In certain aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In certain aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

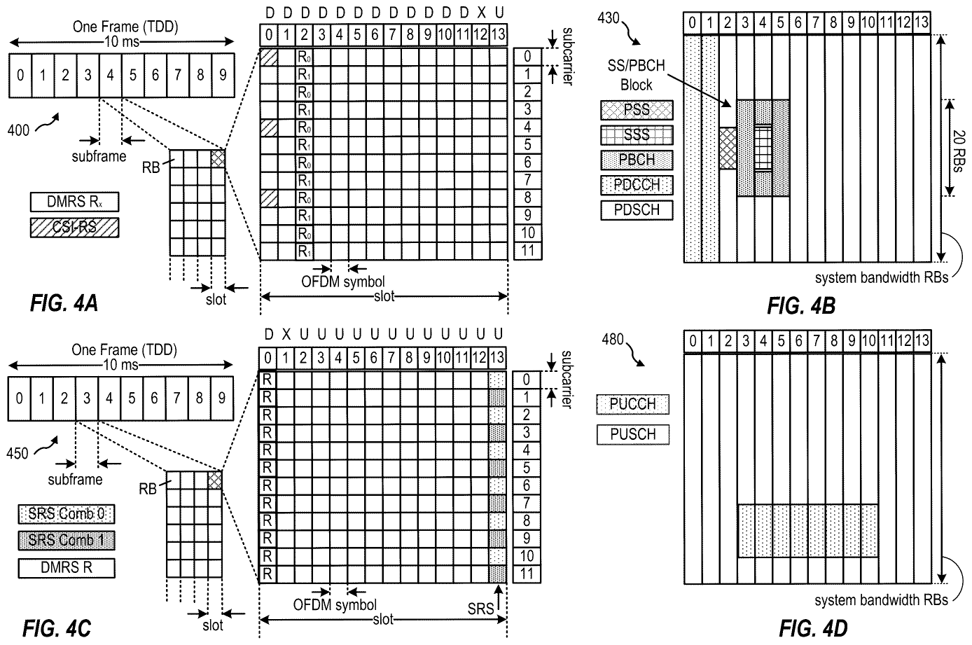

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-Terrestrial Network Communications

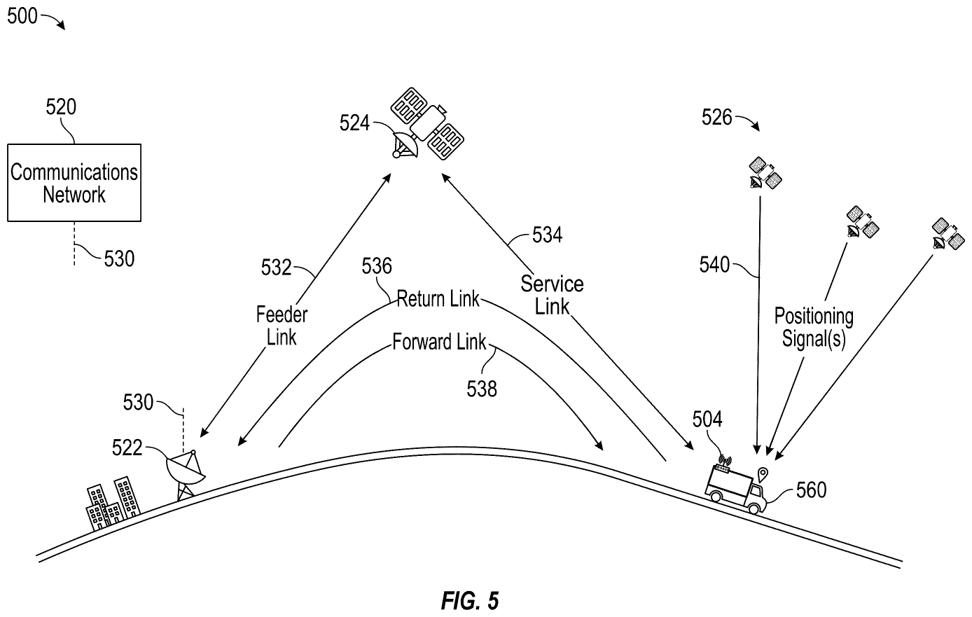

FIG. 5 depicts an example NTN 500. In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). As an example, the UE 504 may be or include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that an IoT device is an example of a UE, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524. In certain aspects, the NTN gateway 522 may be co-located with or include a base station or a disaggregated network entity thereof.

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO) (which includes Low-Earth Orbit (LEO) and Medium Earth Orbit (MEO)), or High Altitude Platform Systems (HAPS).

The NTN payload 524 may transparently forward communications (e.g., according to a radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link). In some aspects, the NTN gateway 522 is implemented at the NTN payload 524. In some aspects, the NTN payload 524 comprises a gNB, a first network entity 300, or a second network entity 302.

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain an indication of the location of the NTN payload 524 via system information from the NTN payload 524. In certain cases, the UE 504 may estimate a timing delay and/or Doppler effects associated with the service link 534 using the positioning signal(s) 540 and the location of the NTN payload 524.

### Aspects Related to Virtual Bandwidth Part-based Interference Measurement

Aspects of the present disclosure provide certain scheme(s) for interference measurement based at least in part on a virtual BWP. The scheme(s) for interference measurement may enable reduced latencies and/or increased throughput, for example, through certain interference mitigation techniques, while complying with certain specification(s) associated with SRS measurement resources and/or RSSI measurement resources (as described above).

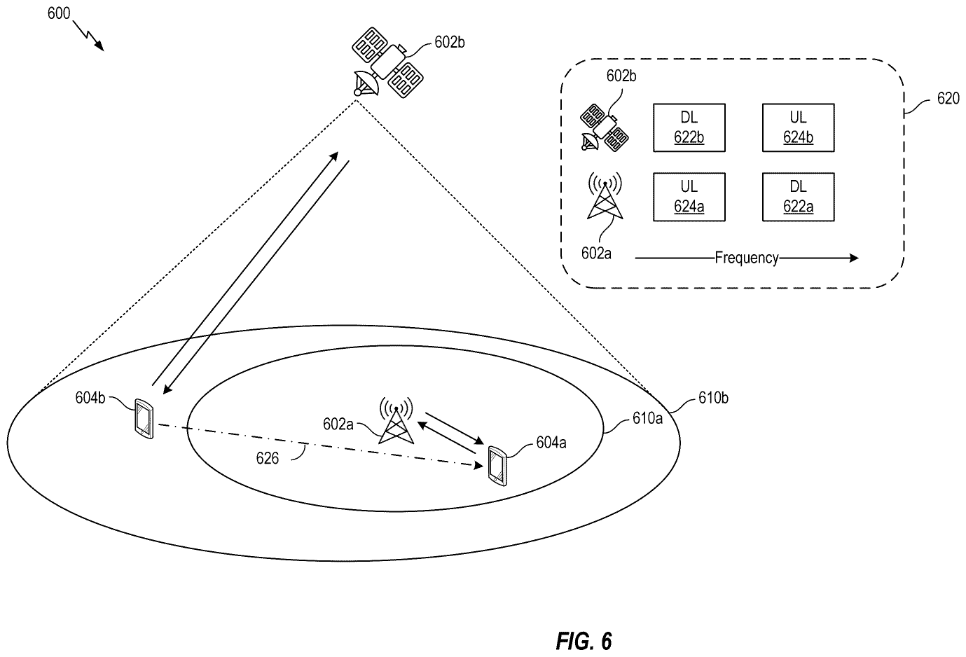

FIG. 6 depicts an example of interference measurement in a wireless communications network 600 where reverse spectrum sharing may be employed, for example, between a NTN and a TN. In this example, the wireless communications network 600 may include a first network node 602a having a first coverage area 610a and a second network node 602b having a second coverage area 610b, which may overlap in space with the first coverage area 610a. For example, the first coverage area 610a may be arranged to be inside the second coverage area 610b. In certain cases, the second coverage area 610b may be non-overlapping with and/or adjacent to the first coverage area 610a. The first network node 602a may be or include a network node associated with the TN, such as the first network entity 300 and/or the second network entity 302 of FIG. 3; and the second network node 602b may be or include an NTN payload (e.g., the NTN payload 524 of FIG. 5). In certain aspects, a first cell associated with the first network node 602a may form the first coverage area 610a, and a second cell associated with the second network node 602b may form the second coverage area 610b.

In certain aspects, the downlink and uplink frequency bands used by the first network node 602a and the second network node 602b may apply FDD spectrum sharing with reverse pairing (e.g., the reverse spectrum sharing 620). As an example, a first UE 604a may be located in the first coverage area 610a, and the first UE 604a may communicate FDD communications with the first network node 602a via a first downlink frequency band 622a and a first uplink frequency band 624a (for communication of downlink signaling and uplink signaling, respectively). The first uplink frequency band 624a may include a first set of frequency resources (for example, as described herein with respect to FIGS. 4A-4D), and the first downlink frequency band 622a may include a second set of frequency resources. The first set of frequency resources may be allocated for uplink communications associated with the first cell, and the second set of frequency resources may be allocated for downlink communications associated with the first cell. Accordingly, the first cell may be the serving cell of the first UE 604a, and the second cell may be a neighbor cell of the first UE 604a.

A second UE 604b may be located in the second coverage area 610b and communicate with the second network node 602b via a second downlink frequency band 622b and a second uplink frequency band 624b. The first downlink frequency band 622a may overlap with the second uplink frequency band 624b in the frequency domain, and the first uplink frequency band 624a may overlap with the second downlink frequency band 622b in the frequency domain. For example, the second downlink frequency band 622b may include the first set of frequency resources, and the second uplink frequency band 624b may include the second set of frequency resources. Accordingly, the first UE 604a may encounter interference (e.g., cross-link interference) in the first downlink frequency band 622a from uplink signaling transmitted by the second UE 604b in the second uplink frequency band 624b. The first UE 604a and the second UE 604b may be examples of the UEs described herein with respect to FIGS. 1-5.

The first UE 604a may be configured to measure the interference from one or more UEs, such as the second UE 604b. As an example, according to aspects described herein, the first UE 604a may obtain (for example, from the first network node 602a) a configuration (which may be or include one or more configurations) that indicates one or more measurement resources, in a virtual BWP, associated with measurement of interference, for example, as further described herein with respect to FIGS. 7 and 8. In certain aspects, the first downlink frequency band 622a may include the virtual BWP. For example, the virtual BWP may be arranged in the first downlink frequency band 622a, and thus, the second uplink frequency band 624b. In certain cases, the first UE 604a may communicate with the first network node 602a via an active or default downlink BWP, which may overlap with the virtual BWP in the frequency domain, as further described herein with respect to FIGS. 7 and 8.

The measurement resource(s) may be configured, based on the virtual BWP, to satisfy one or more parameters associated with the interference, such as a frequency location, a frequency bandwidth, and/or a subcarrier spacing. The measurement resource(s) may enable the first UE 604a to monitor, detect, and/or measure signaling 626 from the second UE 604b. The signaling 626 may be or include SRS transmission(s) and/or uplink transmission(s) (e.g., PUSCH and/or PUCCH transmission(s)) in the second uplink frequency band 624b. In certain cases, the second UE 604b may be configured to transmit SRS transmission(s) for interference measurements at the first UE 604a. In certain cases, the signaling may be or include radiation (e.g., sidelobe radiation) emitted from the second UE 604b while transmitting signaling (via a main lobe) towards the second network node 602b.

In certain cases, due to certain frequency pre-compensations (e.g., Doppler shifts) applied at the second UE 604b, a portion of the signaling 626 in the frequency domain may be outside a frequency bandwidth of the active or default downlink BWP configured at the first UE 604a (where the active or default downlink BWP may be different than the virtual BWP). In certain cases, the second UE 604b may transmit the signaling using a different subcarrier spacing as the active or default downlink BWP configured at the first UE 604a. For example, NTN communications between the second UE 604b and the second network node 602b may only use a subset of subcarrier spacings available for TN communications, for example, between the first UE 604a and the first network node 602a. Thus, the first UE 604a may communicate with the first network node 602a using a different subcarrier spacing as the subcarrier spacing used by the second UE 604b and the second network node 602b.

Due to certain specifications associated with SRS measurement resources and/or RSSI measurement resources (as described above), the first UE 604a may not be able to measure the signaling 626 using measurement resources based on the active or default downlink BWP, for example, based on the frequency location and/or the subcarrier spacing of the signaling 626. The virtual BWP may satisfy one or more parameters associated with the interference and comply with the specifications. Accordingly, the virtual BWP may enable the first UE 604a to monitor, detect, and/or measure the signaling 626 from the second UE 604b, for example, to characterize the interference, which may be encountered in the active or default downlink BWP.

FIG. 7 depicts an example frequency allocation 700 of downlink BWPs in a carrier. In this example, a UE (such as the first UE 604a of FIG. 6) may be configured with a set of downlink BWPs 702 and a virtual BWP 704 arranged in the frequency bandwidth of a carrier 706, which may be a frequency range of one or more operating bands (e.g., n254, n255, n256, n510, n511, or n512) specified for wireless communications. In certain cases, the carrier 706 may be or include the first downlink frequency band 622a and the second uplink frequency band 624b of FIG. 6. In certain cases, the first downlink frequency band 622a and the second uplink frequency band 624b of FIG. 6 may include the carrier 706. The carrier 706 may be associated with the first cell and/or the second cell of FIG. 6.

The set of downlink BWPs 702 may be or include one or more downlink BWPs allocated to the UE for downlink communications. As an example, the set of downlink BWPs 702 may include a first BWP 708a, a second BWP 708b, and so on, through an nth BWP 708n, where n is at least 1 (thus, in some aspects, there may be only one BWP 708 in the set of downlink BWPs 702). Each BWP 708 of the set of downlink BWPs 702 may occupy a contiguous frequency bandwidth (e.g., a contiguous set of resource blocks) in the carrier (though different BWPs 702 need not be contiguous to one another). Each BWP 708 of the set of downlink BWPs 702 may include a PDCCH and/or a PDSCH. Each BWP 708 of the set of downlink BWPs 702 may be associated with a subcarrier spacing, a cyclic prefix, a PDCCH configuration, and/or a PDSCH configuration. Each BWP 708 of the set of downlink BWPs 702 may be associated with a BWP identifier or identity (e.g., a BWP ID). As an example, a BWP 708 of the set of downlink BWPs 702 may be allocated a BWP identity within a specific range of values (e.g., 0 to 4), where the identity having a specific value (e.g., ‘0’) may be reserved to reference an initial downlink BWP for downlink communications.

In certain cases, at least one of the BWPs of the set of downlink BWPs (e.g., the first BWP 708a) may be assigned or activated to be an active (or default) downlink BWP for downlink communications between the UE and a network node, such as the first network node 602a of FIG. 6. The virtual BWP 704 may be configured to overlap with the active or default downlink BWP (e.g., the first BWP 708a). Within an active or default downlink BWP, the UE may monitor certain reference signals for channel state feedback, radio link monitoring, and/or beam management. In certain cases, the UE may monitor for certain control signaling within the active or default downlink BWP, such as RRC signaling, MAC signaling, DCI, and/or the like. For example, such signaling may be expected to occur only within the active or default downlink BWP.

The UE may be configured with up to a threshold number of downlink BWPs per carrier (such as a maximum of 4 BWPs per carrier). In certain cases, the virtual BWP 704 may be exempt from being counted towards the threshold number of downlink BWPs. The virtual BWP 704 may not be counted towards the maximum number of downlink BWPs allocated per carrier. Thus, the total number of BWPs in the set of downlink BWPs 702, without including the virtual BWP 704, may satisfy the threshold number of BWPs (e.g., ≤the threshold number of BWPs).

Note that the first BWP 708a, the second BWP 708b, and the nth BWP 708n are example BWPs, which are depicted as being non-overlapping with each other in the frequency domain. Aspects of the present disclosure may apply to alternative or additional BWP arrangements in the carrier 706, such as the set of downlink BWPs 702 including at least two BWPs that overlap with each other in the frequency domain.

The virtual BWP 704 may be or include a downlink BWP, which may be configured to satisfy or match one or more parameters associated with interference, such as a subcarrier spacing, a frequency bandwidth, or a frequency location of the interference. A downlink BWP that satisfies or matches one or more parameters associated with interference may refer to the downlink BWP having a characteristic or property that enables a UE to detect the interference, such as a subcarrier spacing, a frequency bandwidth, or a frequency location of the interference. For example, the virtual BWP may have the same subcarrier spacing as the interference. The frequency bandwidth of the interference may be within the frequency bandwidth of the virtual BWP. The frequency location of the interference may match the frequency location of the virtual BWP. The virtual BWP 704 may enable the UE to be configured with measurement resource(s) for interference measurement, such as the cross-link interference described herein with respect to FIG. 6. The UE may be configured with measurement resource(s) in the virtual BWP 704, as further described herein with respect to FIG. 8.

The UE may be configured with a frequency domain location 710 and/or a frequency bandwidth 712 of the virtual BWP 704, for example, based on value of a locationAndBandwidth information element. The frequency domain location 710 may indicate a starting position of the virtual BWP 704 in the frequency domain, such as a starting resource block in a frequency resource grid. The frequency domain location 710 may be the lowest frequency of the frequency bandwidth 712 in the carrier 706. The frequency bandwidth 712 of the virtual BWP 704 may occupy a contiguous frequency range of the carrier 706. The frequency bandwidth 712 of the virtual BWP 704 may be different from (e.g., wider than) the frequency bandwidth of the first BWP 708a in the frequency domain. In certain cases, the frequency bandwidth 712 of the virtual BWP 704 may match (e.g., be the same as) the frequency bandwidth of the first BWP 708a in the frequency domain. The frequency bandwidth 712 of the virtual BWP 704 may match or include the frequency bandwidth of uplink communications (e.g., SRS transmissions) from an aggressor UE, such as the second UE 604b.

As an example, the virtual BWP 704 may at least partially overlap with the first BWP 708a in the frequency domain. In certain cases, a portion 714 (e.g., a subband) of the virtual BWP 704 may be outside the frequency bandwidth of the first BWP 708a in the frequency domain. The portion 714 of the virtual BWP 704 may be arranged in the frequency domain to account for certain frequency pre-compensations (e.g., a frequency shift) applied at an aggressor UE (e.g., the second UE 604b of FIG. 6), for example, due to the Doppler shift associated with NTN communications and/or oscillator mismatches between the aggressor UE and the NTN payload. As an example, the portion 714 of the virtual BWP 704 may be arranged in the frequency domain to overlap with at least a portion of the occupied bandwidth of transmissions that undergo the frequency pre-compensation(s) applied at the aggressor UE. In certain cases, the virtual BWP 704 may have the same frequency bandwidth as the first BWP 708a, and thus, the virtual BWP 704 may effectively occupy the frequency range of the first BWP 708a shifted in the frequency domain by a frequency shift, for example, a Doppler shift (and/or other pre-compensations) as applied (or expected to be applied) at the aggressor UE. In certain cases, the frequency bandwidth 712 of the virtual BWP 704 may be wider than the frequency bandwidth of the first BWP 708a in the frequency domain, for example, to account for positive and negative Doppler shifts that reside outside of the frequency bandwidth of the first BWP 708a.

Note that the virtual BWP 704 depicted in FIG. 7 is merely an example. Aspects of the present disclosure may apply to additional or alternative virtual BWP(s), for example, to enable interference measurement that complies with the specification(s) associated with SRS measurement resources and/or RSSI measurement resources. For example, in certain cases, a virtual BWP may be configured to cover the entire bandwidth of the carrier to facilitate interference measurements in any BWP of the set of downlink BWPs 702. As another example, the UE may be configured with a virtual BWP per BWP of the set of downlink BWPs 702. As another example, the UE may be configured with multiple virtual BWPs, such as corresponding to different aggressors, different detected interference, different cells, or the like.

The virtual BWP 704 may be associated with a subcarrier spacing. The subcarrier spacing of the virtual BWP 704 may be different from the subcarrier spacing of the first BWP 708a. The subcarrier spacing of the virtual BWP 704 may match the subcarrier spacing used by an aggressor UE (e.g., the second UE 604b) to communicate with a network node (such as the second network node 602b) and/or to transmit certain signaling (such as SRS transmissions). Thus, the subcarrier spacing of the virtual BWP 704 may match a subcarrier spacing at which a signal causing the interference of an aggressor UE, such as the second UE 604b, is transmitted.

The virtual BWP 704 may be associated with a BWP ID. The BWP ID of the virtual BWP 704 may have a value that is different from the value(s) of the BWP ID(s) associated with the set of downlink BWPs 702. As an example, the value of the BWP ID associated with the virtual BWP 704 may be greater than the threshold number of downlink BWPs and/or greater than the highest BWP ID value configured for a BWP of the set of downlink BWPs 702. For example, if the set of downlink BWPs 702 are configured with BWP IDs 0 through N, the virtual BWP 704 may be configured with a BWP ID of N+1 or a different number other than 0 through N.

In certain cases, the virtual BWP 704 may only be used for channel measurements, such as interference measurement. For example, the UE may only perform interference measurements within OFDM symbols that are configured as measurement resource(s) based at least in part on the virtual BWP 704. The virtual BWP 704 may not be associated with certain parameters used for downlink communications, such as a cyclic prefix, a PDCCH configuration, and/or a PDSCH configuration. As an example, the UE may obtain a configuration of the virtual BWP 704 without one or more of a cyclic prefix, a PDCCH configuration, or a PDSCH configuration. The configuration of the virtual BWP 704 may refrain from indicating (or lack an indication of) a cyclic prefix, a PDCCH configuration, and/or a PDSCH configuration associated with the virtual BWP. Accordingly, the virtual BWP 704 may be configured without a PDCCH, a PDSCH, and/or a cyclic prefix.

In certain aspects, a configuration of the virtual BWP 704 may implicitly or explicitly indicate certain parameter(s) associated with the virtual BWP 704, such as the subcarrier spacing, the frequency domain location 710, and/or the frequency bandwidth 712 of the virtual BWP 704. As an example, the configuration of the virtual BWP 704 may include one or more parameter(s) that explicitly indicate the subcarrier spacing, the frequency domain location 710, and/or the frequency bandwidth 712 of the virtual BWP 704.

As another example, the configuration of the virtual BWP 704 may implicitly indicate the subcarrier spacing, the frequency domain location 710, and/or the frequency bandwidth 712 of the virtual BWP 704, for example, based at least in part on a SRS configuration (e.g., one or more SRS resource configurations). An SRS configuration may indicate a subcarrier spacing, a frequency domain location, and/or a frequency bandwidth associated with one or more SRS resources. An aggressor UE (e.g., the second UE 604b) may be configured with the SRS resource(s) that have the subcarrier spacing, the frequency domain location, and/or the frequency bandwidth indicated in the SRS configuration. A victim UE (e.g., the first UE 604a) may determine that the virtual BWP has the same subcarrier spacing, the frequency domain location, and/or the frequency bandwidth as indicated in the SRS configuration. The victim UE may obtain an indication that the virtual BWP is associated with the SRS configuration. Accordingly, an SRS configuration may implicitly indicate certain parameter(s) associated with the virtual BWP 704.

Thus, the virtual BWP 704 may enable the UE to measure interference from the aggressor UE while complying with the specification(s) associated with SRS measurement resources and/or RSSI measurement resources. For example, the frequency bandwidth 712 of the virtual BWP 704 may enable the UE to measure interference that may reside outside of the first BWP 708a, for example, due to certain frequency pre-compensations applied by the aggressor UE. As another example, the subcarrier spacing of the virtual BWP 704 may match the subcarrier spacing used by an aggressor UE to communicate with a network node (such as the second network node 602b of FIG. 6) and/or transmit an SRS. Thus, the virtual BWP 704 may enable the UE to detect and measure signaling communicated in the OFDM subcarriers used by the aggressor UE.

Accordingly, the virtual BWP-based interference measurements may enable reduced latencies and/or increased throughput. For example, characterization of the interference in the virtual BWP encountered at the victim UE (e.g., the first UE 604a) may allow the victim UE and/or a network node (e.g., the first network node 602a) to mitigate the effects of the interference, for example, through a channel precoder (at the first network node 602a), channel decoder (at the first UE 604a), and/or channel equalization (at the first UE 604a).

FIG. 8 depicts an example scheme 800 of BWP switching between a first downlink BWP (e.g., an active or default BWP) and a second downlink BWP (e.g., a virtual BWP). In this example, a UE (e.g., the first UE 604) may be configured with a first downlink BWP 802 among a set of downlink BWPs (such as the set of downlink BWPs 702 of FIG. 7). The first downlink BWP 802 may be an example of the first BWP 708a of FIG. 7. The UE may also be configured with one or more measurement resources 804 in a second downlink BWP, for example, in a frequency bandwidth 806 of the second downlink BWP. Note that the measurement resource(s) 804 are depicted as being allocated across the entire frequency bandwidth 804 of the second downlink BWP. In certain cases, the measurement resources 804 may be allocated in a portion of the frequency bandwidth 804 of the second downlink BWP. The second downlink BWP may be or include a virtual BWP, for example, as described herein with respect to FIGS. 6 and 7. The second downlink BWP may be an example of the virtual BWP 704 of FIG. 7. The second downlink BWP may be configured to satisfy one or more parameters associated with interference, such as the frequency bandwidth, the frequency location, and/or subcarrier spacing. The one or more parameters associated with the interference may not be satisfied by the first downlink BWP 802. The first downlink BWP 802 may have at least one parameter that is different from the one or more parameters associated with the interference.

The measurement resource(s) 804 may be or include one or more time-frequency resources allocated for interference measurement, such as one or more SRS measurement resource(s) and/or one or more RSSI measurement resource(s). The measurement resource(s) 804 may be periodic, semi-persistent, and/or aperiodic resource(s). In certain cases, the UE may obtain a measurement configuration (e.g., a measurement object configuration) that indicates the measurement resource(s) 804 are associated with the second downlink BWP. The association between the measurement resource(s) 804 and the second downlink BWP may indicate that the measurement resource(s) 804 are arranged in the frequency bandwidth 806 of the second downlink BWP and/or have the same subcarrier spacing as the second downlink BWP.

In certain cases, the UE may be communicating via the first downlink BWP 802. For example, the first downlink BWP 802 may be the default or active downlink BWP of the UE, and the UE may be communicating in a PDSCH and/or PDCCH of the first downlink BWP 802. Then, the UE may switch to the second downlink BWP to perform interference measurement during one or more measurement occasions 808 associated with the measurement resource(s) 804. Thus, the first downlink BWP 802 may be a source downlink BWP, and the second downlink BWP may be a target virtual BWP. The measurement occasion(s) 808 may be or include a time period during which the UE may monitor and/or measure for interference (e.g., the signaling 626 of FIG. 6) in the measurement resource(s) 804 of the second downlink BWP.

The UE may switch to the second downlink BWP after at least a first switch delay 810a occurs prior to beginning of the measurement occasion(s) 808 (e.g., prior to the first symbol in time of the measurement occasion(s) 808). After the measurement occasion(s) 808 (e.g., after the last symbol in time of the measurement occasion(s) 808) and a second switch delay 810b (which may have the same or a different duration as the first switch delay), the UE may switch from the second downlink BWP to the first downlink BWP 802. The UE may be configured to switch from the second downlink BWP to the first downlink BWP 802 after the measurement occasion(s) 808, for example, without additional signaling from a network node.

The switch delay (e.g., the first switch delay 810a and the second switch delay 810b) may provide a minimum amount of time for the UE to tune its transceiver (e.g., the one or more transceivers 324 of FIG. 3) to the frequency bandwidth of the second downlink BWP and/or the first downlink BWP (depending on target BWP). The UE may not be expected to receive signaling in the target BWP (e.g., the second downlink BWP or the first downlink BWP 802) before the switch delay occurs. Thus, at least a switch delay may be arranged in time between a specific event (e.g., a trigger and/or signaling) and the measurement occasion(s) 808; and at least a switch delay may be arranged in time between the measurement occasion(s) 808 and any communications in the first downlink BWP 802. In certain cases, the switch delay may have the same duration as the BWP switching delay used for switching among the set of downlink BWPs (e.g., the set of downlink BWPs 702). In certain cases, the switch delay may have a specific duration for switching to or from a virtual BWP, such as the second downlink BWP. For example, the switch delay for a virtual BWP may be shorter than the switch delays for regular BWPs, for example, in part due to the virtual BWP overlapping with another BWP in the frequency domain and/or having a different subcarrier spacing.

In certain aspects, the UE may obtain signaling 812 (e.g., DCI) that indicates to switch from the first downlink BWP 802 to the second downlink BWP. The UE may switch to the second downlink BWP in response to (e.g., after) receiving the signaling 812. The signaling 812 may include DCI that indicates to switch from the first downlink BWP 802 to the second downlink BWP. The DCI may include one or more fields that indicate a target virtual BWP, such as the second downlink BWP. In certain cases, a bit flag of a field of the DCI may indicate the target downlink BWP is a virtual BWP. In certain cases, the one or more fields may include a BWP ID field, which may indicate the target downlink BWP. The BWP ID field may indicate a codepoint that is linked to a BWP ID. The BWP ID field may have a bit size or length that is large enough to indicate the BWP ID associated with one or more virtual BWPs, such as 3 bits. In certain aspects, the cyclic redundancy check of the DCI may be scrambled with a specific radio network temporary identifier (RNTI) associated with a virtual BWP, such as the second downlink BWP, which may indicate to switch to the virtual BWP. In certain aspects, the DCI may be dedicated to indicating a switch to a virtual BWP, for example, among a set of virtual BWPs.

In certain aspects, the UE may be configured to autonomously switch from the first downlink BWP 802 to the second downlink BWP, for example, based on certain criteria. The UE may determine to switch to the second downlink BWP based on the measurement resource(s) 804 having at least one parameter that is different from the active or default downlink BWP of the UE. As an example, the UE may determine to switch to the second downlink BWP based at least in part on the subcarrier spacing of the first downlink BWP 802 (e.g., the active or default downlink BWP) being different from the subcarrier spacing of the second downlink BWP (e.g., the target virtual BWP associated with the measurement resource(s) 804). In certain cases, the UE may determine to switch to the second downlink BWP based at least in part on any of the frequency resource(s) (e.g., resource blocks) of the measurement resource(s) being arranged outside of the frequency bandwidth of the first downlink BWP 802 (e.g., the active or default downlink BWP). Such autonomous switching may be applied to SRS measurement resource(s) and/or RSSI measurement resource(s).

### Example Signaling of Virtual Bandwidth Part-based Interference Measurement

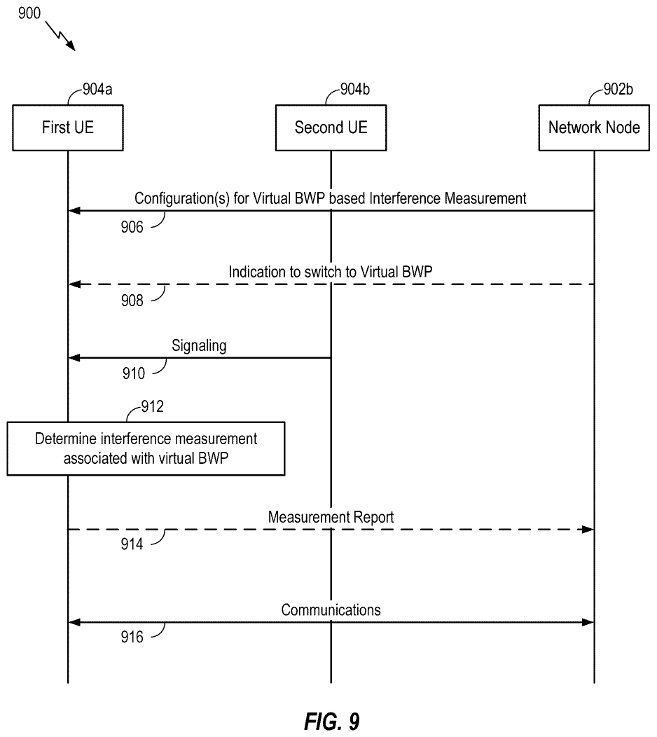

FIG. 9 depicts a process flow 900 for virtual BWP-based interference measurement in a network including a network node 902, a first UE 904a, and a second UE 904b. In certain aspects, the network node 902 may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the network node 902a may be an example of a network node associated with a TN, for example, as described herein with respect to FIG. 6. Similarly, the UE 904a, 904b may be an example of UE 104 depicted and described with respect to FIG. 1 or the UE 304 depicted and described with respect to FIG. 3. However, in other aspects, the UE 904a, 904b may be another type of wireless communications device, and the network node 902 may be another type of network entity or network node, such as those described herein. Note that any operations or signaling illustrated with dashed lines may indicate that that operation or signaling is an optional or alternative example.

In this example, the first UE 904a may be located in a first coverage area (e.g., the first coverage area 610a) of the network node 902, and the second UE 904b may be located in a second coverage area (e.g., the second coverage area 610b) of another network node (not shown), for example, as described herein with respect to FIG. 6. A first cell associated with the network node 902 may form the first coverage area, and a second cell associated with the other network node may form the second coverage area.

At 906, the first UE 904a obtains, from the network node 902, one or more configurations (configuration(s)) that indicate virtual BWP-based interference measurement. As an example, the configuration(s) may indicate a first downlink BWP among a set of downlink BWPs, for example, as described herein with respect to FIG. 7. The first downlink BWP may have a PDCCH and/or PDSCH for downlink communications. The configuration(s) may indicate a second downlink BWP, which may be or include a virtual BWP as described herein with respect to FIG. 7. The second downlink BWP may overlap with the first downlink BWP in the frequency domain, and the second downlink BWP may enable the first UE 904a to measure interference, which may be encountered in the first downlink BWP. The configuration(s) may indicate one or more measurement resources, associated with measurement of interference, in the second downlink BWP, for example, as described herein with respect to FIG. 8. The second downlink BWP may be configured to satisfy one or more parameters associated with interference, such as a frequency location, a frequency bandwidth, and/or a subcarrier spacing. The second downlink BWP may enable the first UE 904a to monitor and/or measure interference, which may affect communications in the first downlink BWP, for example, output by the second UE 904b. The first downlink BWP may have at least one parameter (e.g., frequency bandwidth and/or subcarrier spacing) that is different from the one or more parameters associated with the interference. Thus, any measurement resources associated with the first downlink BWP may not enable the first UE 904a to measure certain interference output by the second UE 904b, such as NTN communications, due to certain specification(s) associated with SRS measurement resources and/or RSSI measurement resources. The configuration(s) may be communicated via RRC signaling, MAC signaling, DCI, system information, and/or the like.

At 908, the first UE 904a optionally obtains, from the network node 902, an indication to switch to the second downlink BWP, for example, as described herein with respect to FIG. 8. The indication to switch to the second downlink BWP may be communicated via RRC signaling, MAC signaling, DCI, system information, and/or the like.

At 910, the first UE 904a monitors for interference in the second downlink BWP during the measurement occasion(s) associated with the measurement resource(s). As an example, the first UE 904a obtains, from the second UE 904b, signaling in second downlink BWP during the measurement occasion(s). The second downlink BWP may enable the first UE 904a to detect, decode, and/or measure certain signaling from the second UE 904b, such as SRS transmission(s). For example, the second downlink BWP may have a frequency bandwidth in which the signaling from the second UE 904b is transmitted. In certain cases, the second downlink BWP may have a subcarrier spacing that matches the subcarrier spacing of the signaling transmitted by the second UE 904b. The signaling may include one or more SRS transmissions, one or more uplink transmission(s) (such as PUSCH and/or PUCCH transmission(s)), and/or the like. The signaling may be communicated in the shared uplink and downlink frequency bands as described herein with respect to FIG. 6. In certain cases, the first UE 904a may switch to the second downlink BWP after a switch delay occurs prior to the beginning of the measurement occasion(s), for example, as described herein with respect to FIG. 8.

At 912, the first UE 904a determines an interference measurement associated with the second downlink BWP. As an example, the first UE 904a may determine a received signal strength (e.g., an RSSI and/or reference signal received power (RSRP)) and/or a received signal quality (e.g., a signal-to-noise ratio (SNR) and/or a signal-to-interference plus noise ratio (SINR)) associated with the signaling.

At 914, the first UE 904a optionally sends, to the network node 902, a measurement report that includes an indication of the interference associated with the second downlink BWP. The indication of the interference may include a received signal quality associated with the signaling (e.g., the received SRS) or a received signal strength associated with the signaling. The measurement report may enable the network node 902 to adjust communications with the first UE 904a, such as frequency allocation, transmit power, modulation and coding scheme (MCS), coding rate, beam configuration, and/or the like.

At 916, the first UE 904a communicates with the network node 902. As an example, the first UE 904a may communicate FDD communications with the network node 902, as described herein with respect to FIG. 6. The first UE 904a may communicate via a first set of frequency resources allocated for uplink communications associated with the first cell of the network node 902, and the first UE 904a may communicate via the second set of frequency resources allocated for downlink communications associated with the first cell of the network node 902. For example, the first UE 904a may send, to the network node 902, uplink signaling via the first set of frequency resources, and the first UE 904a may obtain, from the network node 902, downlink signaling via the second set of frequency resources. In certain cases, the first UE 904a and the network node 902 may communicate with each other via TN communications, for example, as described herein with respect to FIG. 6.

The second downlink BWP may enable the first UE 904a to measure interference from the second UE 904b while complying with the specification(s) associated with SRS measurement resources and/or RSSI measurement resources (for example, in terms of frequency bandwidth and/or subcarrier spacing). Measurement of interference in the second downlink BWP (e.g., the virtual BWP) may enable reduced latencies and/or increased throughput for communications between the first UE 904a and the network node 902. For example, characterization of the interference in the second downlink BWP encountered at the first UE 904a may allow the first UE 904a and/or the network node 902 to mitigate the effects of the interference, for example, in the first downlink BWP, which may overlap with the second downlink BWP as described above.

In certain cases, the first UE 904a may communicate with the network node 902 based on the interference measurement(s) determined at 912. For example, the first UE 904a may adjust a channel decoder and/or channel equalization for downlink communications with the network node 902 based on the interference measurement(s).

In certain cases, the network node 902 may communicate with the first UE 904a based on the measurement report obtained at 914. As an example, the network node 902 may adjust a channel precoder for downlink communications with the first UE 904a based on the interference indicated in the measurement report.

Note that the process flow illustrated in FIG. 9 is described herein to facilitate an understanding of virtual BWP-based interference measurement, for example, in reverse spectrum sharing, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a Virtual BWP-based Interference Measurement

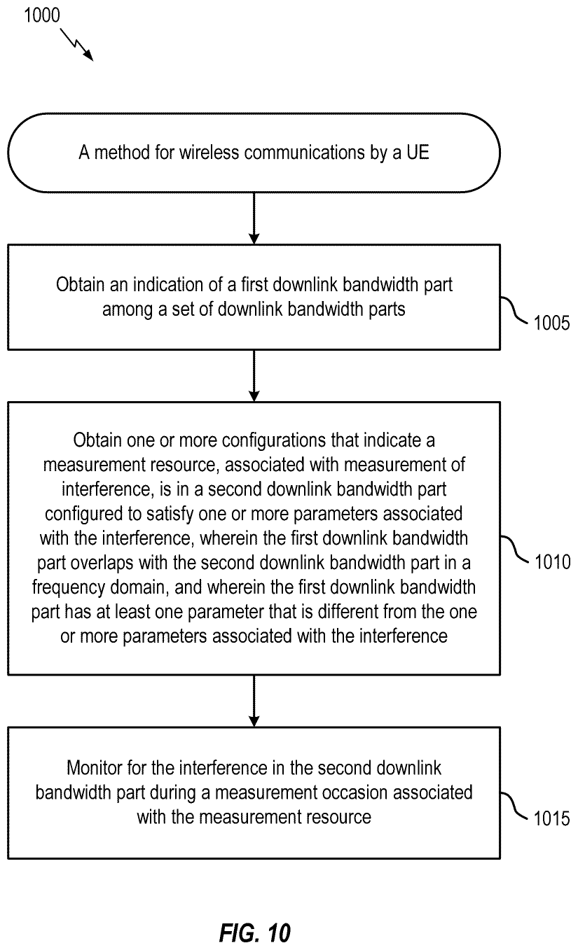

FIG. 10 shows a method 1000 for wireless communications by a UE, such as UE 104 of FIG. 1 or UE 304 of FIG. 3.

Method 1000 begins at block 1005 with obtaining an indication of a first downlink bandwidth part among a set of downlink bandwidth parts, for example, as described herein with respect to FIGS. 6-9.

Method 1000 then proceeds to block 1010 with obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference, for example, as described herein with respect to FIGS. 6-9.

Method 1000 then proceeds to block 1015 with monitoring for the interference in the second downlink bandwidth part during a measurement occasion associated with the measurement resource, for example, as described herein with respect to FIGS. 6-9.

In certain aspects, the first downlink bandwidth part comprises a cyclic prefix, one or more of a physical downlink shared channel, or a physical downlink control channel, and the second downlink bandwidth part is configured without one or more of a cyclic prefix, a physical downlink shared channel, or a physical downlink control channel.

In certain aspects, the first downlink bandwidth part has a first subcarrier spacing and a first frequency bandwidth, wherein at least one of the first subcarrier spacing or the first frequency bandwidth is different from the one or more parameters associated with the interference.

In certain aspects, the one or more configurations indicate that the second downlink bandwidth part includes a second subcarrier spacing that is different from the first subcarrier spacing, and wherein the second subcarrier spacing satisfies the one or more parameters associated with the interference.

In certain aspects, the one or more configurations indicate that the second downlink bandwidth part includes a second frequency bandwidth that at least partially overlaps with the first frequency bandwidth in the frequency domain, and wherein the second frequency bandwidth satisfies the one or more parameters associated with the interference.

In certain aspects, the one or more configurations indicate that the second downlink bandwidth part is associated with a bandwidth part identifier that has a value different from one or more identifiers associated with the set of downlink bandwidth parts.

In certain aspects, the one or more configurations indicate that a total number of the set of downlink bandwidth parts, without including the second downlink bandwidth part, satisfy a threshold number of downlink bandwidth parts.

In certain aspects, the one or more configurations indicate that the second downlink bandwidth part includes one or more of a subcarrier spacing, a frequency domain location, or a frequency bandwidth based at least in part on one or more sounding reference signal resources associated with interference measurement.

In certain aspects, block 1010 includes determining that the one or more sounding reference signal resources indicate one or more of the subcarrier spacing, the frequency domain location, or the frequency bandwidth associated with the second downlink bandwidth part.

In certain aspects, block 1015 includes switching from the first downlink bandwidth part to the second downlink bandwidth part after at least a switch delay occurs prior to the measurement occasion, wherein the first downlink bandwidth part has a first subcarrier spacing and a first frequency bandwidth.

In certain aspects, switching from the first downlink bandwidth part to the second downlink bandwidth part comprises switching from the first downlink bandwidth part to the second downlink bandwidth part based at least in part on the first subcarrier spacing being different from a second subcarrier spacing associated with the measurement occasion.

In certain aspects, switching from the first downlink bandwidth part to the second downlink bandwidth part comprises switching from the first downlink bandwidth part to the second downlink bandwidth part based at least in part on the measurement resource being arranged at least partially outside the first frequency bandwidth of the first downlink bandwidth part.

In certain aspects, the switch delay has a duration associated with bandwidth part switching among the set of downlink bandwidth parts.

In certain aspects, the switch delay has a duration specific to the second downlink bandwidth part.

In certain aspects, method 1000 further includes obtaining an indication to switch from the first downlink bandwidth part to the second downlink bandwidth part.

In certain aspects, the indication includes one or more of: an indication of a virtual bandwidth part identifier associated with the second downlink bandwidth part; downlink control information having a cyclic redundancy check scrambled by a radio network temporary identifier associated with the second downlink bandwidth part; the downlink control information having a field that indicates to switch from the first downlink bandwidth part to the second downlink bandwidth part; or the downlink control information being dedicated to indication to switch from the first downlink bandwidth part to the second downlink bandwidth part.

In certain aspects, method 1000 further includes switching from the second downlink bandwidth part to the first downlink bandwidth part after one or more interference measurements associated with the measurement resource.

In certain aspects, method 1000 further includes communicating with a network node based at least in part on one or more measurements of the interference associated with the second downlink bandwidth part.

In certain aspects, method 1000 further includes sending a measurement report that includes an indication of the interference associated with the second downlink bandwidth part.

In certain aspects, the measurement resource includes one or more of a sounding reference signal resource or a RSSI resource.

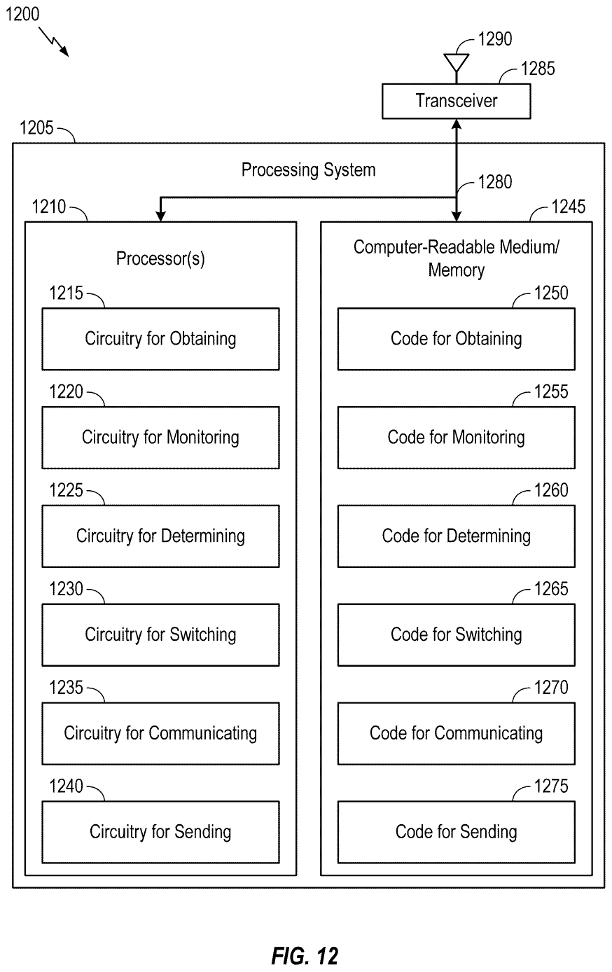

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

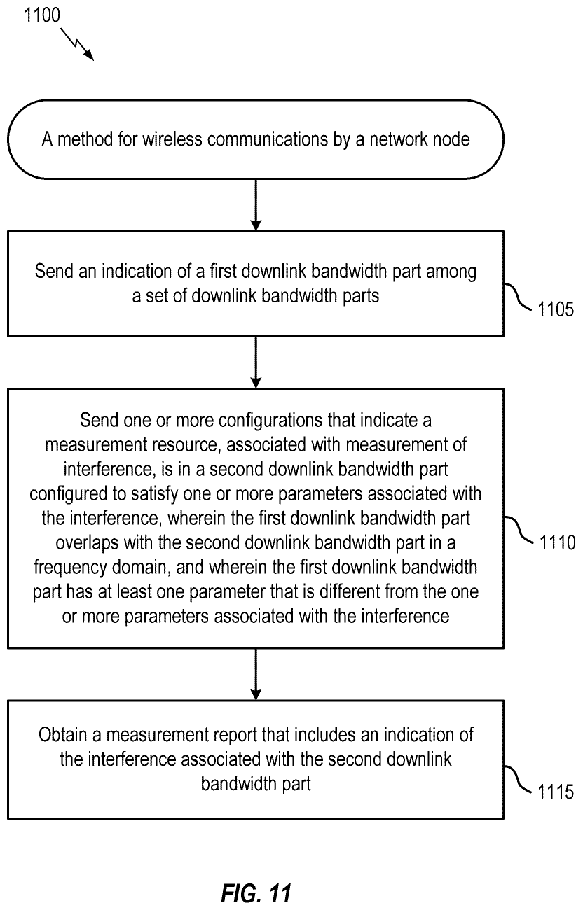

FIG. 11 shows a method 1100 for wireless communications by a network node, such as BS 102 of FIG. 1, a first network entity 300 or second network entity 302 of FIG. 3, or a disaggregated base station as discussed with respect to FIG. 2.

Method 1100 begins at block 1105 with sending an indication of a first downlink bandwidth part among a set of downlink bandwidth parts, for example, as described herein with respect to FIGS. 6-9.

Method 1100 then proceeds to block 1110 with sending one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference, for example, as described herein with respect to FIGS. 6-9.

Method 1100 then proceeds to block 1115 with obtaining a measurement report that includes an indication of the interference associated with the second downlink bandwidth part, for example, as described herein with respect to FIGS. 6-9.

In certain aspects, the first downlink bandwidth part comprises a cyclic prefix, one or more of a physical downlink shared channel, or a physical downlink control channel, and the second downlink bandwidth part is configured without one or more of a cyclic prefix, a physical downlink shared channel, or a physical downlink control channel.

In certain aspects, the first downlink bandwidth part has a first subcarrier spacing and a first frequency bandwidth, wherein at least one of the first subcarrier spacing or the first frequency bandwidth is different from the one or more parameters associated with the interference.

In certain aspects, the one or more configurations indicate that the second downlink bandwidth part includes a second subcarrier spacing that is different from the first subcarrier spacing, and wherein the second subcarrier spacing satisfies the one or more parameters associated with the interference.

In certain aspects, the one or more configurations indicate that the second downlink bandwidth part includes a second frequency bandwidth that at least partially overlaps with the first frequency bandwidth in the frequency domain, and wherein the second frequency bandwidth satisfies the one or more parameters associated with the interference.

In certain aspects, the one or more configurations indicate that the second downlink bandwidth part is associated with a bandwidth part identifier that has a value different from one or more identifiers associated with the set of downlink bandwidth parts.

In certain aspects, the one or more configurations indicate that a total number of the set of downlink bandwidth parts, without including the second downlink bandwidth part, satisfy a threshold number of downlink bandwidth parts.

In certain aspects, the one or more configurations indicate that the second downlink bandwidth part includes one or more of a subcarrier spacing, a frequency domain location, or a frequency bandwidth based at least in part on one or more sounding reference signal resources associated with interference measurement.

In certain aspects, method 1100 further includes sending an indication of the one or more sounding reference signal resources that indicate one or more of the subcarrier spacing, the frequency domain location, or the frequency bandwidth associated with the second downlink bandwidth part.

In certain aspects, the one or more configurations indicate to switch from the first downlink bandwidth part to the second downlink bandwidth part after at least a switch delay occurs prior to a measurement occasion associated with the measurement resource, wherein the first downlink bandwidth part has a first subcarrier spacing and a first frequency bandwidth.

In certain aspects, the one or more configurations indicate to switch from the first downlink bandwidth part to the second downlink bandwidth part based at least in part on the first subcarrier spacing being different from a second subcarrier spacing associated with the measurement occasion.

In certain aspects, the one or more configurations indicate to switch from the first downlink bandwidth part to the second downlink bandwidth part based at least in part on the measurement resource being arranged at least partially outside the first frequency bandwidth of the first downlink bandwidth part.

In certain aspects, the switch delay has a duration associated with bandwidth part switching among the set of downlink bandwidth parts.

In certain aspects, the switch delay has a duration specific to the second downlink bandwidth part.

In certain aspects, method 1100 further includes sending an indication to switch from the first downlink bandwidth part to the second downlink bandwidth part.

In certain aspects, the indication includes one or more of: an indication of a virtual bandwidth part identifier associated with the second downlink bandwidth part; downlink control information having a cyclic redundancy check scrambled by a radio network temporary identifier associated with the second downlink bandwidth part; the downlink control information having a field that indicates to switch from the first downlink bandwidth part to the second downlink bandwidth part; or the downlink control information being dedicated to indication to switch from the first downlink bandwidth part to the second downlink bandwidth part.

In certain aspects, the one or more configurations indicate to switch from the second downlink bandwidth part to the first downlink bandwidth part after one or more interference measurements associated with the measurement resource.

In certain aspects, the measurement resource includes one or more of a sounding reference signal resource or a RSSI resource.

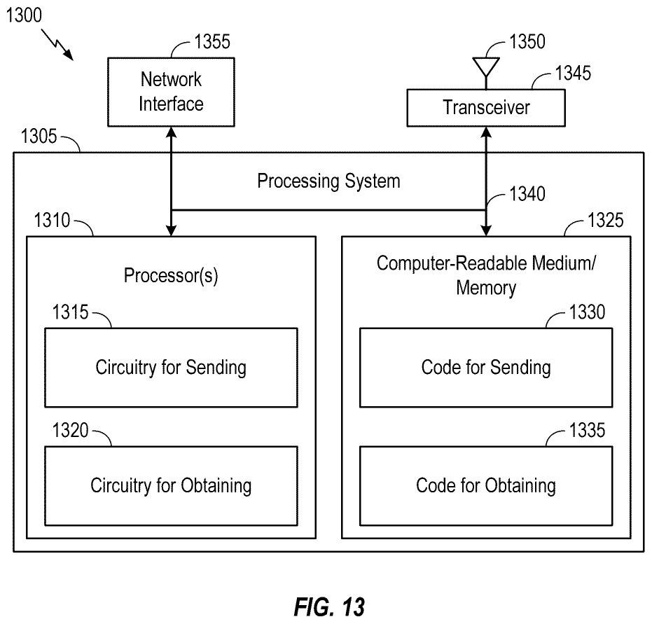

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In certain aspects, communications device 1200 is a user equipment, such as UE 104 described above with respect to FIG. 1 or UE 304 described with respect to FIG. 3.

The communications device 1200 includes a processing system 1205 coupled to a transceiver 1285 (e.g., a transmitter and/or a receiver). The transceiver 1285 is configured to transmit and receive signals for the communications device 1200 via an antenna 1290, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1245. In various aspects, the one or more processors 1210 may be representative of the one or more processors 318 described with respect to FIG. 3. The one or more processors 1210 are coupled to a computer-readable medium/memory 1245 via a bus 1280. In certain aspects, the computer-readable medium/memory 1245 may be representative of the one or more memories 320 described with respect to FIG. 3. The computer-readable medium/memory 1245 is a non-transitory computer-readable medium/memory. In certain aspects, the computer-readable medium/memory 1245 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1245 stores code (e.g., executable instructions), including code for obtaining 1250, code for monitoring 1255, code for determining 1260, code for switching 1265, code for communicating 1270, and code for sending 1275. Processing of the code 1250-1275 may enable and cause the communications device 1200 to perform the method 1000 described with respect to FIG. 10, or any aspect related to it. For example, in certain aspects, code for obtaining 1250 may include code for obtaining an indication of a first downlink bandwidth part among a set of downlink bandwidth parts. In certain aspects, code for obtaining 1250 may include code for obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference. In certain aspects, code for monitoring 1255 may include code for monitoring for the interference in the second downlink bandwidth part during a measurement occasion associated with the measurement resource.

The one or more processors 1210 include circuitry configured to implement (e.g., execute) the code stored in the computer-readable medium/memory 1245, including circuitry for obtaining 1215, circuitry for monitoring 1220, circuitry for determining 1225, circuitry for switching 1230, circuitry for communicating 1235, and circuitry for sending 1240. Processing with circuitry 1215-1240 may enable and cause the communications device 1200 to perform the method 1000 described with respect to FIG. 10, or any aspect related to it. For example, in certain aspects, circuitry for obtaining 1215 may include circuitry for obtaining an indication of a first downlink bandwidth part among a set of downlink bandwidth parts. In certain aspects, circuitry for obtaining 1215 may include circuitry for obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference. In certain aspects, circuitry for monitoring 1220 may include circuitry for monitoring for the interference in the second downlink bandwidth part during a measurement occasion associated with the measurement resource.

More generally, means for communicating, transmitting, sending or outputting for transmission may include the one or more transceivers 324, one or more antenna 322 and/or processing system 316 of the UE 304 illustrated in FIG. 3, transceiver 1285 and/or antenna 1290 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1285 and/or antenna 1290 of the communications device 1200 in FIG. 12, and/or one or more processors 1210 of the communications device 1200 in FIG. 12. For example, means for monitoring, means for determining, and/or means for switching of the method 1000 described with respect to FIG. 10, or any aspect related to it, may include the processing system 316 of the UE 304 illustrated in FIG. 3, and/or one or more processors 1210 of the communications device 1200 in FIG. 12.

FIG. 13 depicts aspects of an example communications device configured for wireless communications. In certain aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, one or more processors 1310 may be representative of the one or more processors 308, as described with respect to FIG. 3. The one or more processors 1310 are coupled to the computer-readable medium/memory 1325 via a bus 1340. In certain aspects, the computer-readable medium/memory 1325 is configured to store instructions (e.g., computer-executable code), including code 1330 and 1335, that when executed by the one or more processors 1310, cause the one or more processors 1310 to perform the method 1100 described with respect to FIG. 11, or any aspect related to it, including any operations described in relation to FIG. 11. The computer-readable medium/memory 1325 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1325 stores code (e.g., executable instructions), including code for sending 1330 and code for obtaining 1335. Processing of the code 1330 and 1335 may enable and cause the communications device 1300 to perform the method 1100 described with respect to FIG. 11, or any aspect related to it. For example, in certain aspects, code for sending 1330 may include code for sending an indication of a first downlink bandwidth part among a set of downlink bandwidth parts. In certain aspects, code for sending 1330 may include code for sending one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference. In certain aspects, code for obtaining 1335 may include code for obtaining a measurement report that includes an indication of the interference associated with the second downlink bandwidth part.

The one or more processors 1310 include circuitry configured to implement (e.g., execute) the code stored in the computer-readable medium/memory 1325, including circuitry for sending 1315 and circuitry for obtaining 1320. Processing with circuitry 1315 and 1320 may enable and cause the communications device 1300 to perform the method 1100 described with respect to FIG. 11, or any aspect related to it. For example, in certain aspects, circuitry for sending 1315 may include circuitry for sending an indication of a first downlink bandwidth part among a set of downlink bandwidth parts. In certain aspects, circuitry for sending 1315 may include circuitry for sending one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference. In certain aspects, circuitry for obtaining 1320 may include circuitry for obtaining a measurement report that includes an indication of the interference associated with the second downlink bandwidth part.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by a UE comprising: obtaining an indication of a first downlink bandwidth part among a set of downlink bandwidth parts; obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and monitoring for the interference in the second downlink bandwidth part during a measurement occasion associated with the measurement resource.
Clause 2: The method of Clause 1, wherein: the first downlink bandwidth part comprises a cyclic prefix, one or more of a physical downlink shared channel, or a physical downlink control channel, and the second downlink bandwidth part is configured without one or more of a cyclic prefix, a physical downlink shared channel, or a physical downlink control channel.
Clause 3: The method of any one of Clauses 1-2, wherein the first downlink bandwidth part has a first subcarrier spacing and a first frequency bandwidth, wherein at least one of the first subcarrier spacing or the first frequency bandwidth is different from the one or more parameters associated with the interference.
Clause 4: The method of Clause 3, wherein the one or more configurations indicate that the second downlink bandwidth part includes a second subcarrier spacing that is different from the first subcarrier spacing, and wherein the second subcarrier spacing satisfies the one or more parameters associated with the interference.
Clause 5: The method of Clause 3, wherein the one or more configurations indicate that the second downlink bandwidth part includes a second frequency bandwidth that at least partially overlaps with the first frequency bandwidth in the frequency domain, and wherein the second frequency bandwidth satisfies the one or more parameters associated with the interference.
Clause 6: The method of any one of Clauses 1-5, wherein the one or more configurations indicate that the second downlink bandwidth part is associated with a bandwidth part identifier that has a value different from one or more identifiers associated with the set of downlink bandwidth parts.
Clause 7: The method of any one of Clauses 1-6, wherein the one or more configurations indicate that a total number of the set of downlink bandwidth parts, without including the second downlink bandwidth part, satisfy a threshold number of downlink bandwidth parts.
Clause 8: The method of any one of Clauses 1-7, wherein the one or more configurations indicate that the second downlink bandwidth part includes one or more of a subcarrier spacing, a frequency domain location, or a frequency bandwidth based at least in part on one or more sounding reference signal resources associated with interference measurement.
Clause 9: The method of Clause 8, wherein obtaining the one or more configurations comprises determining that the one or more sounding reference signal resources indicate one or more of the subcarrier spacing, the frequency domain location, or the frequency bandwidth associated with the second downlink bandwidth part.
Clause 10: The method of any one of Clauses 1-9, wherein monitoring for the interference comprises switching from the first downlink bandwidth part to the second downlink bandwidth part after at least a switch delay occurs prior to the measurement occasion, wherein the first downlink bandwidth part has a first subcarrier spacing and a first frequency bandwidth.
Clause 11: The method of Clause 10, wherein switching from the first downlink bandwidth part to the second downlink bandwidth part comprises switching from the first downlink bandwidth part to the second downlink bandwidth part based at least in part on the first subcarrier spacing being different from a second subcarrier spacing associated with the measurement occasion.
Clause 12: The method of Clause 10, wherein switching from the first downlink bandwidth part to the second downlink bandwidth part comprises switching from the first downlink bandwidth part to the second downlink bandwidth part based at least in part on the measurement resource being arranged at least partially outside the first frequency bandwidth of the first downlink bandwidth part.
Clause 13: The method of Clause 10, wherein the switch delay has a duration associated with bandwidth part switching among the set of downlink bandwidth parts.
Clause 14: The method of Clause 10, wherein the switch delay has a duration specific to the second downlink bandwidth part.
Clause 15: The method of Clause 10, further comprising obtaining an indication to switch from the first downlink bandwidth part to the second downlink bandwidth part.
Clause 16: The method of Clause 15, wherein the indication includes one or more of: an indication of a virtual bandwidth part identifier associated with the second downlink bandwidth part; downlink control information having a cyclic redundancy check scrambled by a radio network temporary identifier associated with the second downlink bandwidth part; the downlink control information having a field that indicates to switch from the first downlink bandwidth part to the second downlink bandwidth part; or the downlink control information being dedicated to indication to switch from the first downlink bandwidth part to the second downlink bandwidth part.
Clause 17: The method of any one of Clauses 1-16, further comprising switching from the second downlink bandwidth part to the first downlink bandwidth part after one or more interference measurements associated with the measurement resource.
Clause 18: The method of any one of Clauses 1-17, further comprising communicating with a network node based at least in part on one or more measurements of the interference associated with the second downlink bandwidth part.
Clause 19: The method of any one of Clauses 1-18, further comprising sending a measurement report that includes an indication of the interference associated with the second downlink bandwidth part.
Clause 20: The method of any one of Clauses 1-19, wherein the measurement resource includes one or more of a sounding reference signal resource or a RSSI resource.
Clause 21: A method for wireless communications by a network node comprising: sending an indication of a first downlink bandwidth part among a set of downlink bandwidth parts; sending one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and obtaining a measurement report that includes an indication of the interference associated with the second downlink bandwidth part.
Clause 22: The method of Clause 21, wherein: the first downlink bandwidth part comprises a cyclic prefix, one or more of a physical downlink shared channel, or a physical downlink control channel, and the second downlink bandwidth part is configured without one or more of a cyclic prefix, a physical downlink shared channel, or a physical downlink control channel.
Clause 23: The method of any one of Clauses 21-22, wherein the first downlink bandwidth part has a first subcarrier spacing and a first frequency bandwidth, wherein at least one of the first subcarrier spacing or the first frequency bandwidth is different from the one or more parameters associated with the interference.
Clause 24: The method of Clause 23, wherein the one or more configurations indicate that the second downlink bandwidth part includes a second subcarrier spacing that is different from the first subcarrier spacing, and wherein the second subcarrier spacing satisfies the one or more parameters associated with the interference.
Clause 25: The method of Clause 23, wherein the one or more configurations indicate that the second downlink bandwidth part includes a second frequency bandwidth that at least partially overlaps with the first frequency bandwidth in the frequency domain, and wherein the second frequency bandwidth satisfies the one or more parameters associated with the interference.
Clause 26: The method of any one of Clauses 21-25, wherein the one or more configurations indicate that the second downlink bandwidth part is associated with a bandwidth part identifier that has a value different from one or more identifiers associated with the set of downlink bandwidth parts.
Clause 27: The method of any one of Clauses 21-26, wherein the one or more configurations indicate that a total number of the set of downlink bandwidth parts, without including the second downlink bandwidth part, satisfy a threshold number of downlink bandwidth parts.
Clause 28: The method of any one of Clauses 21-27, wherein the one or more configurations indicate that the second downlink bandwidth part includes one or more of a subcarrier spacing, a frequency domain location, or a frequency bandwidth based at least in part on one or more sounding reference signal resources associated with interference measurement.
Clause 29: The method of Clause 28, further comprising sending an indication of the one or more sounding reference signal resources that indicate one or more of the subcarrier spacing, the frequency domain location, or the frequency bandwidth associated with the second downlink bandwidth part.
Clause 30: The method of any one of Clauses 21-29, wherein the one or more configurations indicate to switch from the first downlink bandwidth part to the second downlink bandwidth part after at least a switch delay occurs prior to a measurement occasion associated with the measurement resource, wherein the first downlink bandwidth part has a first subcarrier spacing and a first frequency bandwidth.
Clause 31: The method of Clause 30, wherein the one or more configurations indicate to switch from the first downlink bandwidth part to the second downlink bandwidth part based at least in part on the first subcarrier spacing being different from a second subcarrier spacing associated with the measurement occasion.
Clause 32: The method of Clause 30, wherein the one or more configurations indicate to switch from the first downlink bandwidth part to the second downlink bandwidth part based at least in part on the measurement resource being arranged at least partially outside the first frequency bandwidth of the first downlink bandwidth part.
Clause 33: The method of Clause 30, wherein the switch delay has a duration associated with bandwidth part switching among the set of downlink bandwidth parts.
Clause 34: The method of Clause 30, wherein the switch delay has a duration specific to the second downlink bandwidth part.
Clause 35: The method of Clause 30, further comprising sending an indication to switch from the first downlink bandwidth part to the second downlink bandwidth part.
Clause 36: The method of Clause 35, wherein the indication includes one or more of: an indication of a virtual bandwidth part identifier associated with the second downlink bandwidth part; downlink control information having a cyclic redundancy check scrambled by a radio network temporary identifier associated with the second downlink bandwidth part; the downlink control information having a field that indicates to switch from the first downlink bandwidth part to the second downlink bandwidth part; or the downlink control information being dedicated to indication to switch from the first downlink bandwidth part to the second downlink bandwidth part.
Clause 37: The method of any one of Clauses 21-36, wherein the one or more configurations indicate to switch from the second downlink bandwidth part to the first downlink bandwidth part after one or more interference measurements associated with the measurement resource.
Clause 38: The method of any one of Clauses 21-37, wherein the measurement resource includes one or more of a sounding reference signal resource or a RSSI resource.
Clause 39: One or more apparatuses, comprising: one or more memories comprising executable instructions; and one or more processors configured to execute the executable instructions and cause the one or more apparatuses to perform a method in accordance with any one of Clauses 1-38.
Clause 40: One or more apparatuses configured for wireless communications, comprising: one or more memories; and one or more processors, coupled to the one or more memories, configured to cause the one or more apparatuses to perform a method in accordance with any one of Clauses 1-38.
Clause 41: One or more apparatuses configured for wireless communications, comprising: one or more memories; and one or more processors, coupled to the one or more memories, configured to perform a method in accordance with any one of Clauses 1-38.
Clause 42: One or more apparatuses, comprising means for performing a method in accordance with any one of Clauses 1-38.
Clause 43: One or more non-transitory computer-readable media comprising executable instructions that, when executed by one or more processors of one or more apparatuses, cause the one or more apparatuses to perform a method in accordance with any one of Clauses 1-38.
Clause 44: One or more computer program products embodied on one or more computer-readable storage media comprising code for performing a method in accordance with any one of Clauses 1-38.
Clause 45: One or more apparatuses configured for wireless communications, comprising: a processing system that includes one or more processors and one or more memories coupled with the one or more processors, the processing system configured to cause the one or more apparatuses to perform a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain an indication of a first downlink bandwidth part among a set of downlink bandwidth parts;
obtain one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and
monitor for the interference in the second downlink bandwidth part during a measurement occasion associated with the measurement resource.

2. The apparatus of claim 1, wherein:
the first downlink bandwidth part comprises a cyclic prefix, one or more of a physical downlink shared channel, or a physical downlink control channel, and
the second downlink bandwidth part is configured without one or more of a cyclic prefix, a physical downlink shared channel, or a physical downlink control channel.

3. The apparatus of claim 1, wherein the first downlink bandwidth part has a first subcarrier spacing and a first frequency bandwidth, wherein at least one of the first subcarrier spacing or the first frequency bandwidth is different from the one or more parameters associated with the interference.

4. The apparatus of claim 3, wherein the one or more configurations indicate that the second downlink bandwidth part includes a second subcarrier spacing that is different from the first subcarrier spacing, and wherein the second subcarrier spacing satisfies the one or more parameters associated with the interference.

5. The apparatus of claim 3, wherein the one or more configurations indicate that the second downlink bandwidth part includes a second frequency bandwidth that at least partially overlaps with the first frequency bandwidth in the frequency domain, and wherein the second frequency bandwidth satisfies the one or more parameters associated with the interference.

6. The apparatus of claim 1, wherein the one or more configurations indicate that the second downlink bandwidth part is associated with a bandwidth part identifier that has a value different from one or more identifiers associated with the set of downlink bandwidth parts.

7. The apparatus of claim 1, wherein the one or more configurations indicate that a total number of the set of downlink bandwidth parts, without including the second downlink bandwidth part, satisfy a threshold number of downlink bandwidth parts.

8. The apparatus of claim 1, wherein the one or more configurations indicate that the second downlink bandwidth part includes one or more of a subcarrier spacing, a frequency domain location, or a frequency bandwidth based at least in part on one or more sounding reference signal resources associated with interference measurement.

9. The apparatus of claim 8, wherein to cause the UE to obtain the one or more configurations, the processing system is configured to cause the UE to determine that the one or more sounding reference signal resources indicate one or more of the subcarrier spacing, the frequency domain location, or the frequency bandwidth associated with the second downlink bandwidth part.

10. The apparatus of claim 1, wherein to cause the UE to monitor for the interference, the processing system is configured to cause the UE to switch from the first downlink bandwidth part to the second downlink bandwidth part after at least a switch delay prior to the measurement occasion, wherein the first downlink bandwidth part has a first subcarrier spacing and a first frequency bandwidth.

11. The apparatus of claim 10, wherein to cause the UE to switch from the first downlink bandwidth part to the second downlink bandwidth part, the processing system is configured to cause the UE to switch from the first downlink bandwidth part to the second downlink bandwidth part based at least in part on the first subcarrier spacing being different from a second subcarrier spacing associated with the measurement occasion.

12. The apparatus of claim 10, wherein to cause the UE to switch from the first downlink bandwidth part to the second downlink bandwidth part, the processing system is configured to cause the UE to switch from the first downlink bandwidth part to the second downlink bandwidth part based at least in part on the measurement resource being arranged at least partially outside the first frequency bandwidth of the first downlink bandwidth part.

13. The apparatus of claim 10, wherein the switch delay has a duration associated with bandwidth part switching among the set of downlink bandwidth parts.

14. The apparatus of claim 10, wherein the switch delay has a duration specific to the second downlink bandwidth part.

15. The apparatus of claim 10, wherein the processing system is configured to cause the UE to obtain an indication to switch from the first downlink bandwidth part to the second downlink bandwidth part.

16. The apparatus of claim 15, wherein the indication includes one or more of:
an indication of a virtual bandwidth part identifier associated with the second downlink bandwidth part;
downlink control information having a cyclic redundancy check scrambled by a radio network temporary identifier associated with the second downlink bandwidth part;
the downlink control information having a field that indicates to switch from the first downlink bandwidth part to the second downlink bandwidth part; or
the downlink control information being dedicated to indication to switch from the first downlink bandwidth part to the second downlink bandwidth part.

17. The apparatus of claim 1, wherein the processing system is configured to cause the UE to switch from the second downlink bandwidth part to the first downlink bandwidth part after one or more interference measurements associated with the measurement resource.

18. An apparatus for wireless communications, comprising a processing system that includes one or more processors and one or more memories coupled with the one or more processors, the processing system configured to cause a network node to:
send an indication of a first downlink bandwidth part among a set of downlink bandwidth parts;
send one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and
obtain a measurement report that includes an indication of the interference associated with the second downlink bandwidth part.

19. The apparatus of claim 18, wherein:
the first downlink bandwidth part comprises a cyclic prefix, one or more of a physical downlink shared channel, or a physical downlink control channel, and
the second downlink bandwidth part is configured without one or more of a cyclic prefix, a physical downlink shared channel, or a physical downlink control channel.

20. A method for wireless communications by a user equipment (UE), comprising:
obtaining an indication of a first downlink bandwidth part among a set of downlink bandwidth parts;
obtaining one or more configurations that indicate a measurement resource, associated with measurement of interference, is in a second downlink bandwidth part configured to satisfy one or more parameters associated with the interference, wherein the first downlink bandwidth part overlaps with the second downlink bandwidth part in a frequency domain, and wherein the first downlink bandwidth part has at least one parameter that is different from the one or more parameters associated with the interference; and
monitoring for the interference in the second downlink bandwidth part during a measurement occasion associated with the measurement resource.
